(19) United States
(12) Patent Application Publication
(10) Pub. No.: US 2022/0301796 A1
(43) Pub. Date: Sep. 22, 2022

(54) Spring Assembly for Biasing an Armature of a Switching Device, and Switching Device Comprising Such Spring Assembly

(71) Applicant: Tyco Electronics Austria GmbH, Vienna (AT)

(72) Inventors: Markus Gutmann, Vienna (AT); Philipp Harrer, Vienna (AT)

(73) Assignee: Tyco Electronics Austria GmbH, Vienna (AT)

(21) Appl. No.: 17/837,114

(22) Filed: Jun. 10, 2022

Related U.S. Application Data
(63) Continuation of application No. PCT/EP2020/085178, filed on Dec. 9, 2020.

(30) Foreign Application Priority Data
Dec. 11, 2019 (EP) 19215307.0

(51) Int. Cl. H01H 50/04; H01H 51/06; H01H 50/18

(52) U.S. Cl. CPC H01H 50/041; H01H 51/06; H01H 50/18

(57) ABSTRACT

A spring assembly for biasing an armature of a switching device includes a spring base and a spring arm protruding from the spring base. The spring base has an embossment positioning the spring assembly in the switching device. The spring arm biases the armature.

### CROSS-REFERENCE TO RELATED APPLICATIONS

This application is a continuation of PCT International Application No. PCT/EP2020/085178, filed on Dec. 9, 2020, which claims priority under 35 U.S.C. § 119 to European Patent Application No. 19215307.0, filed on Dec. 11, 2019.

### FIELD OF THE INVENTION

The invention relates to a spring assembly for biasing an armature of a switching device, such as a relay, and a switching device, such as an electromagnetic switching device, like a relay.

### BACKGROUND

A switching device, such as an electromagnetic relay, is a basic component of household appliances and is used in power plants and power grids as a switch or a protective device. Such electromagnetic devices comprise an electromagnet, a yoke or core, a movable armature which opens/closes the switch based upon a magnetic field produced by the electromagnet, and a spring assembly for biasing the armature. In a rest or initial position, no electric field is generated by the electromagnet, and the spring assembly biases the armature into either the closed or the open position of the switching device. When the electromagnet is energized and a magnetic field is produced, the armature is moved against the biasing force of the spring assembly into the activated position. The activated position is an open position in case of a closed switch in the initial position, and vice versa.

To satisfy market demands, the development of electromagnetic switching devices, such as relays, is trending towards miniaturization, high reliability and so on. The spring assembly for such switching devices often requires a high manufacturing complexity and assembly of the switching device is laborious, leading to complex structures and low manufacturing and assembly efficiency.

### SUMMARY

A spring assembly for biasing an armature of a switching device includes a spring base and a spring arm protruding from the spring base. The spring base has an embossment positioning the spring assembly in the switching device. The spring arm biases the armature.

### BRIEF DESCRIPTION OF THE DRAWINGS

The invention will now be described by way of example with reference to the accompanying Figures, of which:

FIG. 1 is a perspective view of a spring assembly according to an embodiment;

FIG. 2 is a top view of the spring assembly of FIG. 1;

FIG. 3 is a rear view of the spring assembly of FIG. 1;

FIG. 4 is a side view of the spring assembly of FIG. 1; and

FIG. 5 is a top view of a switching device according to an embodiment comprising the spring assembly of FIG. 1.

### DETAILED DESCRIPTION OF THE EMBODIMENT(S)

In the following, the inventive solution will be explained in more detail with reference to the drawings. The features shown in the embodiments can be combined arbitrarily as desired, and are advantageous on their own.

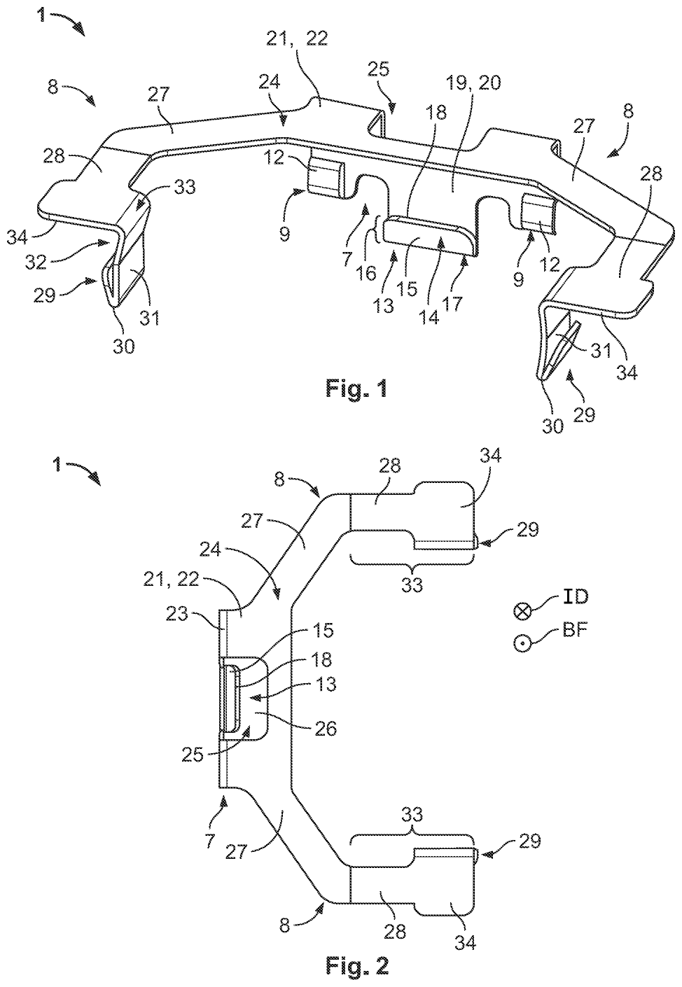

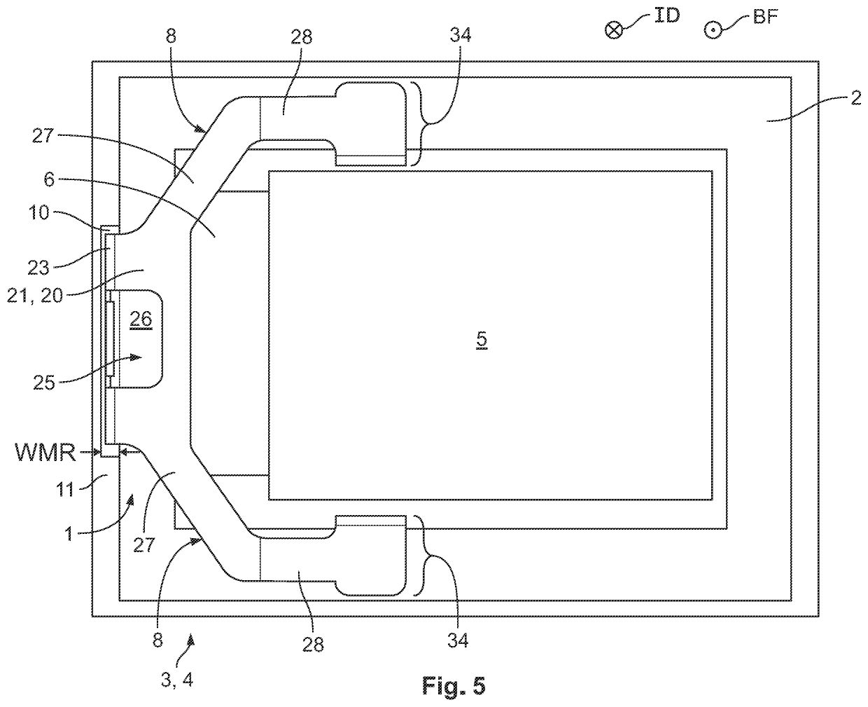

In FIGS. 1 to 4, an embodiment of a spring assembly 1 is shown. The spring assembly 1 is for biasing an armature 2 of a switching device 3, e.g. an electromagnetic switching device, like a relay 4. As shown in FIG. 5, such a switching device 3 comprises, in addition to the spring assembly 1 and the armature 2, an electromagnet 5 and a yoke or core 6 for attracting the armature 2, if the electromagnet 6 produces an electric field, against a biasing force BF provided by the spring assembly 1.

The spring assembly 1 comprises a spring base 7, and at least one spring arm 8 that protrudes from the spring base 7 for biasing the armature 2 into an initial or rest position. In the rest position, the at least one spring arm 8 moves the armature 2 away from the yoke 6 in the direction of the biasing force BF.

The spring base 7 has at least one embossment 9 for positioning the spring assembly 1 in the switching device 3. The at least one embossment 9, in the shown embodiment, is configured for press-fittingly positioning the spring assembly 1 in the switching device 3. The embossment 9 is a projecting elevation or bulge, such as a curved projection, raising out of the spring base 7. This is easy to manufacture and allows to simply mount and position the spring assembly 1 with the switching device 3.

The spring assembly 1 is mounted in the switching device 3 by pushing it in an insertion direction ID into a mounting receptacle 10. In the embodiment shown in FIG. 5, the mounting receptacle 10 is limited on one side by the yoke 6 and on the opposite side by the positioning wall 11 of the switching device 3. The insertion direction ID is opposite the direction of the biasing force BF. Thus, the spring assembly 1 can be easily positioned in the switching device 3 by pushing its spring base 7 in the insertion direction ID into the mounting receptacle 10, in which it is positioned press-fittingly due to the at least one embossment 9 provided on the spring base 7. The positioning wall 11 can be a continuous wall over the whole width of the spring base 7 or the whole spring assembly 1. Alternatively, the positioning wall 11 can be provided merely opposite the embossments 9.

To press-fittingly position the spring assembly 1, the width of the mounting receptacle WMR is smaller than the thickness of the spring base 7, including the height HE of the embossment 9, i.e. the measure by which the embossment 9 stands out from the spring base 7. If the height HE of the embossment 9 is equal to or slightly smaller than the width WMR of the mounting receptacle 10, the spring assembly 1 may be positioned, however, not press-fittingly fixed.

Upon pushing the spring base 7 into the mounting receptacle 10 in the insertion direction ID, the embossment 9 is compressed and, due to the compression, press-fittingly positions the spring assembly 1 in the switching device 3. No additional fixation devices such as screws or rivets are necessary, thus minimizing the number of components needed and facilitating the mounting of the spring assembly 1. Further, due to the press-fitting provided by the embossment 9, no constructive restrictions with respect to mounting the spring assembly 1 arise.

In the shown embodiment, the at least one embossment 9 forms a protuberant pad 12 that is designed as a cushion, bulging out of the spring base 7. The protuberant pad 12 evenly distributes the pressing forces for positioning over a desired surface area. Such a protuberant pad 12 results in a simple and compact construction and can be easily manufactured in a manner allowing to push-in the spring assembly 1 for mounting and press-fittingly position it in the switching device 3.

In the shown embodiment, the spring base 7 comprises two embossments 9. The two embossments 9 are spaced apart from each other in a direction perpendicular to the insertion direction ID, in which the spring base 7 is mounted in the switching device 3. The two embossments 9 are arranged at opposite ends of the spring base 7. Such a construction enhances stability by more evenly distributing the press-fitting positioning force over the area of the spring base 7.

The spring base 7 further comprises a base securing element 13 for locking the spring assembly 1 against removal in its mounting position in the mounting receptacle 10 of the switching device 3. In the shown embodiment, the base securing element 13 is a latching element 14, that is designed as a latching hook or finger 15, formed by a folded back hook section 16 of the spring base 7. In other embodiments, the latching element 14 can be a notch, a slot, or a recess to be connected with a corresponding counter element, such as a hook or nose. In an embodiment, the base securing element 13 can engage the yoke 6.

The hook section 16 is provided at a distal edge 17 of the spring base 7 facing in the insertion direction ID. The hook section 16 is folded or bent back against the insertion direction ID, thus forming a deflectable hook or finger, comprising a stopping face 18 on the free end of the latching hook 15. The stopping face 18 points against the insertion direction ID.

When mounting the spring assembly 1 in the switching device 3 by pushing its spring base 7 in the insertion direction ID into the mounting receptacle 10, the latching hook 15 is deflected and pressed against the spring base 7 until it passes the yoke 6 and engages and abuts with its stopping face 18 at the yoke 6. This way, the spring assembly 1 is secured in its mounting position and cannot be removed from the switching device 3 against the insertion direction ID, due to being locked at the yoke 6 (see e.g. FIG. 4).

In the shown embodiment, the spring base 7 is angular, comprising as a first leg 19 a positioning area 20, and as a second leg 21 a spring support area 22. The first leg 19 and second leg 20 are connected by an elbow 23. The positioning area 20 comprises the two embossments 9, as well as the base securing element 13, designed as a latching hook 15. At the spring support area 22, the proximal end 24 of the spring arm 8 is held. Such an angular spring base 7 provides a compact design, in which the spring arms 8 may be arranged in the area perpendicular to the insertion direction ID. The elbow 23 provides a spring characteristic allowing the second leg 21 to be deflected relative to the form-fittingly positioned first leg 19 that is locked in the mounting receptacle 10.

In the shown embodiment, the spring base 7 further comprises a spring rate adjustment section 25. In the spring rate adjustment section 25, material is removed from the spring base 7. For removal, the material may be cut off in the spring base 7, producing a through-hole 26 that is arranged at the elbow 23. In the shown embodiment, material is removed from the elbow 23 and both the first leg 19 and the second leg 21 of the spring base 7. The form, design and position of the spring rate adjustment section 25 allows to provide a desired spring rate/biasing force BF that is optimized for the respective switching device 3.

In the embodiment shown in FIG. 5, the armature 2 is O-shaped, designed as a frame, laterally surrounding, if viewed in the insertion direction ID, the electromagnet 5. The exemplary embodiment of the spring assembly 1 shown in the Figures comprises two spring arms 8 that both point away from the same side of the spring base 7. Such a design is particularly suited to bias parallel legs of an O-shaped armature 2. The two spring arms 8 each comprise a proximal orientation section 27, whose proximal end 24 is connected with the spring support area 22 of the spring base 7. The proximal orientation section 27 of the two spring arms 8 protrude away from the spring base 7, oblique to each other. That is, the two spring arms 8 extend, at least in sections, oblique to each other, designed in a V-shape. This design reduces the material required, compared to e.g. U-shaped designs.

Each spring arm 8 also comprises a distal attachment section 28, at which the spring arm 8 is connected with the armature 2 in a manner biasing the armature 2 in the direction of the biasing force BF in a very compact, yet efficient design. This can be seen in particular in FIG. 5. The distal attachment section 28 runs parallel, in the shown embodiment, and flush with parallel legs of the O-shaped armature in the insertion direction 10. In another embodiment, the distal attachment sections 28 of two spring arms 8 run parallel to each other.

For connecting the spring arm 8 with the armature 2, the spring arm 8 comprises an attachment element 29. In the shown embodiment, the attachment element 29 is a positive-locking element 30, that is form-fittingly connected with the armature 2. To do so, the positive-locking element 30 comprises a spring latching element 31 that is designed as a clip or clamp 32. The spring latching element 31 surrounds the armature 2 at at least two sides, namely at the side facing in the insertion direction ID, i.e. direction against the biasing force BF, and a lateral side, perpendicular to the biasing force BF.

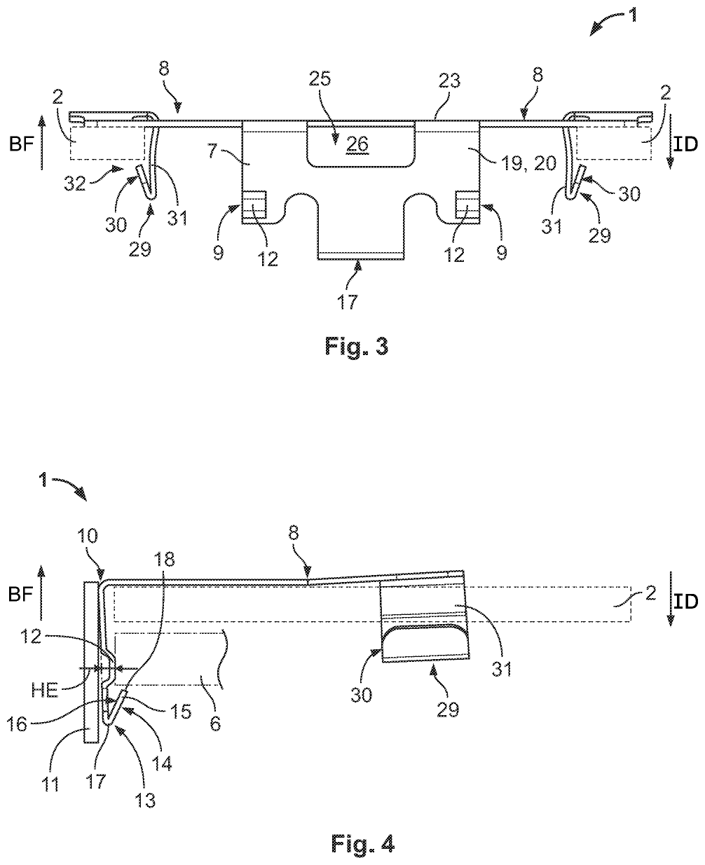

The spring latching element 31, in the shown embodiment, is arranged at a lateral edge 33 of the spring arm 8. It could likewise be arranged at the distal end 34 of the spring arm 8. This way, the spring arm 8 engages the armature 3 from three sides, as can be seen in FIG. 3, the sides facing in and against the biasing force BF/insertion direction ID, and one lateral side thereof. Connecting such an attachment element 29 with the armature 2 can simply be achieved by providing a clip 32 designed as a deflectable latching hook protruding from the spring arm 8 against the biasing direction BF. Pressing the clip 32 against the biasing force BF along the armature 2 brings it into engagement therewith.

In an alternative embodiment, the attachment element 29 may be designed as a flat attachment pad on the distal end 34. Such a pad may be provided with a hole, through which the spring arm 8 can be fixed on the armature, e.g. by laser welding, an adhesive joint, or other ways of material bonding. Using a fastening device, such as a screw or rivet, is also possible.

In the shown embodiment, the spring assembly 1 of the present invention is monolithically formed. This can keep the manufacturing process of the spring assembly 1 simple. The spring assembly 1 can be made from sheet metal, that is cut out from a sheet of metal and subsequently bent and punched to achieve the desired shape, such as the shape of the exemplary embodiment shown in FIGS. 1 to 5.

What is claimed is:

1. A spring assembly for biasing an armature of a switching device, comprising:
a spring base having an embossment positioning the spring assembly in the switching device; and
a spring arm protruding from the spring base and biasing the armature.

2. The spring assembly of claim 1, wherein the embossment press-fittingly positions the spring assembly in the switching device.

3. The spring assembly of claim 1, wherein the embossment forms a protuberant pad.

4. The spring assembly of claim 1, wherein the embossment is one of a pair of embossments of the spring base.

5. The spring assembly of claim 1, wherein the spring base has a base securing element locking the spring assembly in the switching device.

6. The spring assembly of claim 5, wherein the base securing element is a latching element.

7. The spring assembly of claim 1, wherein the spring base is angular and has a first leg and a second leg.

8. The spring assembly of claim 7, wherein the first leg is a positioning area with the embossment.

9. The spring assembly of claim 8, wherein the second leg is a spring support area holding a proximal end of the spring arm.

10. The spring assembly of claim 1, wherein the spring base has a spring rate adjustment section.

11. The spring assembly of claim 1, wherein the spring arm is one of a pair of spring arms protruding from the spring base.

12. The spring assembly of claim 11, wherein the pair of spring arms extend oblique to each other.

13. The spring assembly of claim 12, wherein the spring arms each have a proximal orientation section connected with the spring base and extending away from the spring base.

14. The spring assembly of claim 1, wherein the spring arm has an attachment element connecting the spring arm with the armature.

15. The spring assembly of claim 14, wherein the attachment element is a positive-locking element.

16. The spring assembly of claim 14, wherein the attachment element is arranged at a distal end or a lateral edge of the spring arm.

17. The spring assembly of claim 1, wherein the spring base is monolithically formed with the spring arm in a single piece.

18. A switching device, comprising:
a mounting receptacle; and
a spring assembly including a spring base and a spring arm protruding from the spring base, the spring base having an embossment positioning the spring assembly in the mounting receptacle.

19. The switching device of claim 18, further comprising a yoke and a positioning wall, the mounting receptacle is defined between the yoke and the positioning wall.

20. The switching device of claim 18, further comprising an armature, the spring arm biases the armature.
